(19) United States
(12) Patent Application Publication
(10) Pub. No.: US 2017/0357592 A1
(43) Pub. Date: Dec. 14, 2017

(54) ENHANCED-SECURITY PAGE SHARING IN A VIRTUALIZED COMPUTER SYSTEM

(71) Applicant: VMware, Inc., Palo Alto, CA (US)

(72) Inventors: Gabriel TARASUK-LEVIN, San Jose, CA (US); Pratap SUBRAHMANYAM, Saratoga, CA (US); Rajesh VENKATASUBRAMANIAN, San Jose, CA (US)

(21) Appl. No.: 15/177,843

(22) Filed: Jun. 9, 2016

(51) Int. Cl. G06F 12/1009; G06F 12/02; G06F 9/455; G06F 3/06

(52) U.S. Cl. CPC G06F 12/1009; G06F 3/0608; G06F 3/0673; G06F 3/0667; G06F 12/0292; G06F 9/45558; G06F 3/0652; G06F 2212/152; G06F 2212/1044; G06F 2009/45583

(57) ABSTRACT

An example method of page sharing in a host computer having virtualization software that supports execution of a plurality of virtualized computing instances includes identifying, by the virtualization software, duplicate memory pages in system memory of the host computer. The method further includes sharing a memory page of the duplicate memory pages among the plurality of virtualized computing instances. The method further includes monitoring reads by a first virtualized computing instance targeting the shared memory page. The method further includes creating a private copy of the shared memory page for the first virtualized computing instance in response to the reads satisfying a threshold read pattern.

### BACKGROUND

Computer virtualization is a technique that involves encapsulating a physical computing machine platform into virtual machine(s) executing under control of virtualization software on a hardware computing platform or “host.” A virtual machine provides virtual hardware abstractions for processor, memory, storage, and the like to a guest operating system. The virtualization software, also referred to as a “hypervisor,” includes one or more virtual machine monitors (VMMs) to provide execution environment(s) for the virtual machine(s). As physical hosts have grown larger, with greater processor core counts and terabyte memory sizes, virtualization has become key to the economic utilization of available hardware.

One technique for reducing the amount of system memory allocated among virtual machines is to implement a memory sharing scheme. In one approach, system memory is conserved by eliminating duplicate copies of memory pages and allowing virtual machines to share certain memory pages. Such an approach can reduce memory consumption associated with running multiple instances of the same guest operating systems within the virtual machines. A memory sharing scheme, however, should be secure such that one virtual machine cannot observe or manipulate memory in use by another virtual machine.

### SUMMARY

One or more embodiments provide a method of page sharing in a host computer having virtualization software that supports execution of a plurality of virtualized computing instances. The method includes identifying, by the virtualization software, duplicate memory pages in system memory of the host computer. The method further includes sharing a memory page of the duplicate memory pages among the plurality of virtualized computing instances. The method further includes monitoring reads by a first virtualized computing instance targeting the shared memory page. The method further includes creating a private copy of the shared memory page for the first virtualized computing instance in response to the reads satisfying a threshold read pattern.

In another embodiment, a computer includes a hardware platform having a central processing unit (CPU) and a system memory. The computer further includes virtualization software executing on the hardware platform that supports execution of a plurality of virtualized computing instances. The virtualization software is configured to identify duplicate memory pages in the system memory. The virtualization software is further configured to share a memory page of the duplicate memory pages among the plurality of virtualized computing instances. The virtualization software is further configured to monitor reads by a first virtualized computing instance targeting the shared memory page. The virtualization software is further configured to create a private copy of the shared memory page for the first virtualized computing instance in response to the reads satisfying a threshold read pattern.

Further embodiments include a non-transitory computer-readable storage medium comprising instructions that cause a computer system to carry out the above method.

### BRIEF DESCRIPTION OF THE DRAWINGS

FIG. 1 is a block diagram of a computing system in which one or more embodiments of the present disclosure may be utilized.

FIG. 2 is a block diagram depicting a logical view of a virtualization environment according to an embodiment.

FIG. 3 is a flow diagram depicting a method of enhanced-security page sharing in a virtualized computer system according to embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

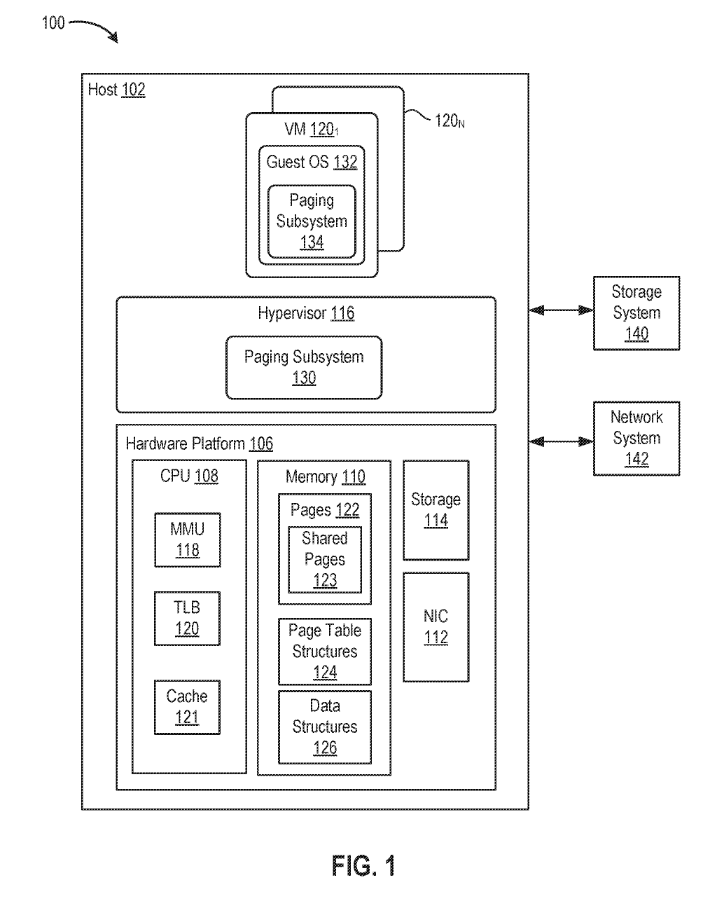

FIG. 1 is a block diagram of a computing system 100 in which one or more embodiments of the present disclosure may be utilized. Computing system 100 includes a host computer system (“host 102”) and, optionally, a storage system 140 and a network system 142. Network system 142 can include gateways, routers, firewalls, switches, local area networks (LANs), and the like. Storage system 140 can include storage area networks (SANs), network attached storage (NAS), fibre channel (FC) networks, and the like. Host 102 may be constructed on a server grade hardware platform 106, such as an x86 architecture platform or the like. Host 102 can be coupled to network system 142 and storage system 140.

As shown, hardware platform 106 includes conventional components of a computing device, such as one or more processors (CPUs) 108, system memory 110 (also referred to as “memory 110”), a network interface 112, storage system 114, and other I/O devices such as, for example, a mouse and keyboard (not shown). CPU 108 is configured to execute instructions, for example, executable instructions that perform one or more operations described herein and may be stored in memory 110 and in local storage. CPU 108 can include a memory management unit (MMU) 118 and a translation lookaside buffer (TLB) 120. While MMU 118 and TLB 120 are shown as part of CPU 108, as is the case in an x86 platform, such components can be separate from CPU 108 in other platforms. MMU 118 performs virtual memory management, primarily translation of logical memory addresses to machine memory addresses. TLB 120 comprises a cache (having one or more levels) that is used by MMU 118 to speed-up address translation. If CPU 108 includes multiple cores, CPU 108 can include multiple instances of MMU 118 and TLB 120.

Memory 110 is a device allowing information, such as executable instructions and data to be stored and retrieved. Memory 110 may include, for example, one or more random access memory (RAM) modules (e.g., volatile dynamic RAM (DRAM)), byte addressable persistent memory, or the like. Network interface 112 enables host 102 to communicate with another device via a communication medium, such as network systems 142. Network interface 112 may be one or more network adapters, also referred to as a Network Interface Card (NIC). Storage system 114 represents local storage devices (e.g., one or more hard disks, flash memory modules, solid state disks, and optical disks) and/or a storage interface that enables host 102 to communicate with one or more network data storage systems, such as storage systems 140. Examples of a storage interface are a host bus adapter (HBA) that couples host 102 to one or more storage arrays, such as a SAN or a NAS, as well as other network data storage systems.

Host 102 executes virtualization software that abstracts processor, memory, storage, and networking resources of hardware platform 106 into multiple virtual machines (VMs) 120₁ through 120_{N} (collectively “VMs 120”) that run concurrently on host 102, where N is an integer greater than zero. VMs 120 run on top of virtualization software, shown as a hypervisor 116, which implements platform virtualization and enables sharing of the hardware resources of host 102 by VMs 120. One example of hypervisor 116 that may be configured and used in embodiments described herein is a VMware ESXi™ hypervisor provided as part of the VMware vSphere® solution made commercially available from VMware, Inc. of Palo Alto, Calif. (although it should be recognized that any other virtualization technologies, including Xen® and Microsoft Hyper-V® virtualization technologies may be utilized consistent with the teachings herein). Each VM 120 supports execution of a guest operating system (OS) 132. Guest OS 132 can be any commodity operating system known in the art, such as Linux®, Microsoft Windows®, Mac OS®, or the like.

In the example shown, hypervisor 116 is a Type-1 hypervisor (also referred to as a “bare-metal hypervisor”) that executes directly on hardware platform 106. In other embodiments, host 102 can include a Type-2 hypervisor (also referred to as a “hosted hypervisor”) that executes on an operating system. One example of a Type-2 hypervisor that may be configured and used in embodiments described herein is VMware Workstation Pro™ made commercially available from VMware, Inc. (although it should be recognized that any other hosted hypervisor can be used consistent with the teachings herein, such as VirtualBox® or the like). The term “hypervisor” as used herein encompasses both Type-1 and Type-2 hypervisors, as well as hybrids thereof (e.g., a Kernel-based Virtual Machine (KVM) infrastructure operating on a Linux® kernel).

Hypervisor 116 includes a paging subsystem 130. As is well known, system memory 110 can be divided into individually addressable units known as “pages.” Each page (also referred to herein as a “memory page”) includes a plurality of separately addressable data words, each of which in turn includes one or more bytes. Pages are identified by addresses commonly referred to as “page numbers.” CPU 108 can support one or more page sizes. For example, modern x86 CPUs can support 4 kilobyte (KB), 2 megabyte (MB), 4 MB, and 1 gigabyte (GB) page sizes. Other CPUs may support other page sizes. The example page sharing techniques described herein do not presuppose any particular page size. However, in general, larger page sizes lead to less likely page sharing opportunities. In some embodiments, the “pages” processed using the page sharing techniques set forth herein can be sub-pages of the actual memory pages (e.g. large pages can be subdivided into smaller pages).

In general, MMU 118 cooperates with paging subsystem 130 to perform address translation between a logical address space of a logical memory and a machine address space of system memory 110. CPU 108 handles reads and writes at a finer granularity than pages (e.g., CPU 108 can access individual data words or even bytes of data words). MMU 118 performs address translation and protection checks at the granularity of pages. When translating a logical address to a machine address, MMU 118 first looks in TLB 120 for an entry that maps a logical page number in the logical address to a machine page number of a machine address. If a TLB miss occurs, MMU 118 walks through a page table structure maintained by paging subsystem 130 to find a page table entry (PTE) that maps the logical page number to the machine page number. MMU 118 uses PTEs in the page table structure to update TLB 120. If there is no PTE for the logical page number being translated, CPU 108 generates a page fault, which is handled by a page fault handler in paging subsystem 130. PTEs can also specify memory protections, usually in a format dictated by TLB 120. For example, a PTE can include write protection field(s), privilege field(s), active/inactive (present/not present) field(s), and the like. If the write or read request does not satisfy the specified memory protections, CPU 108 generates a page fault (sometimes referred to as a “minor page fault”).

As is known, a CPU can support multiple contexts. A “context” as used herein refers to any component that addresses, writes to, and reads from system memory 110 using its own logical memory having its own logical address space. For a traditional OS, a context is typically a process that includes its own virtual memory and virtual address space. For virtualization software, a context is a virtualized computing instance that includes its own logical memory and logical address space assigned by the virtualization software. For hypervisor 116, a context is a VM 120 that includes its own guest physical memory and guest physical address space. “Logical memory” as used herein is memory that is visible to a context and accessible through a logical address space referred to as a “logical address space.” For each context, MMU 118 translates logical addresses within a logical address space to machine addresses within the machine address space. Each address (logical or machine) includes an upper portion that specifies a page number and a lower portion that specifies an offset. MMU 118 relies on a paging subsystem to maintain page table structures that map logical address spaces to the machine address space. Since pages are regions in system memory 110, pages include machine addresses within the machine address space referred to herein as “machine page numbers” (rather than “physical page numbers” to avoid confusion with guest physical memory, discussed below). In general, contexts can refer to pages within logical memory using logical addresses referred to herein as “logical page numbers.”

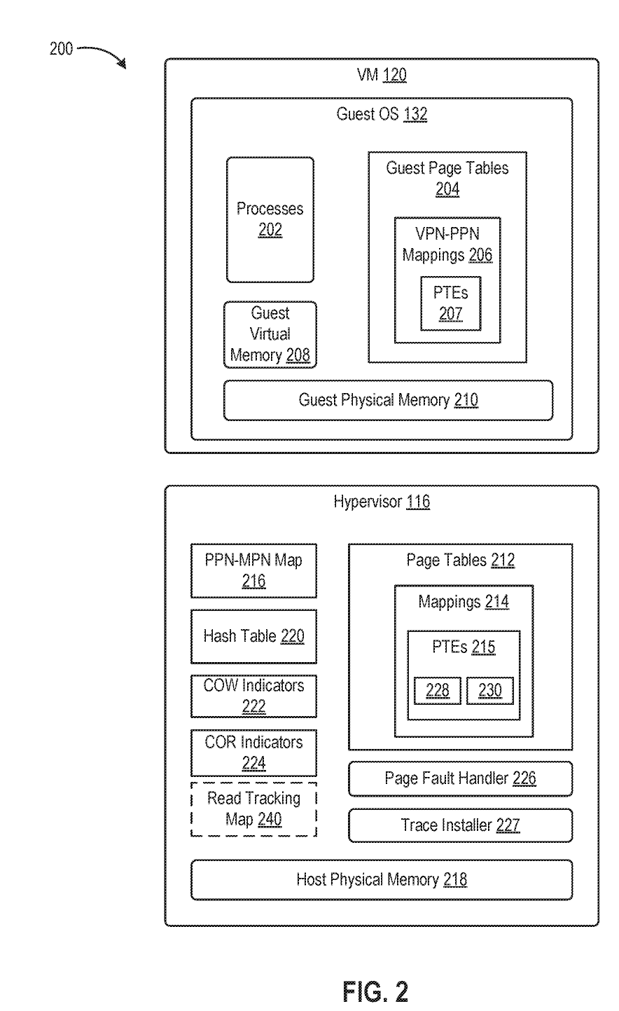

FIG. 2 is a block diagram depicting a logical view of a VM 120 and hypervisor 116 according to an embodiment. Referring to FIGS. 1 and 2, hypervisor 116 implements platform virtualization to provide execution environments for VMs 120, including virtualization of system memory 110. System memory 110 is visible to hypervisor 116 as host physical memory 218 using the machine address space (e.g., machine page numbers). Hypervisor 116 allocates a logical memory (shown as guest physical memory 210) to each VM 120 from the host physical memory 218. Guest physical memory 210 is visible to guest OS 132 using a logical address space referred to as guest physical address space. Guest OS 132 allocates a logical memory to each process executing therein from the guest physical memory 210 shown as guest virtual memory 208. Guest virtual memory 208 is a continuous logical address space presented by guest OS 132 to executing processes 202 using a guest virtual address space. Pages in guest virtual memory 208 are addressed using guest virtual page numbers (also referred to as “virtual page numbers” (VPNs)). Pages in guest physical memory 210 are addressed using guest physical page numbers (also referred to as “physical page numbers” (PPNs)). Pages in host physical memory 218 are addressed using machine page numbers (MPNs). VPNs and PPNs are examples of logical page numbers discussed above.

Guest OS 132 includes paging subsystem 134 configured to manage page tables (“guest page tables 204”) that map guest virtual memory to guest physical memory (e.g., VPNs to PPNs). Guest page tables 204 include a hierarchy of page tables that provides VPN-to-PPN mappings 206 implemented using PTEs 207. In an embodiment, hypervisor 116 emulates the functions of an MMU and a TLB for guest OS 132 (software virtualization of MMU 218). In such an embodiment, guest page tables 204 are not exposed to MMU 118 and TLB 120. Paging subsystem 130 in hypervisor 116 maintains table(s) that map guest physical memory to host physical memory (PPN-MPN map 216). Paging subsystem 130 also includes page tables 212 (sometimes referred to as “shadow page tables”) that map guest virtual memory to host physical memory (e.g., VPNs to MPNs). Page tables 212 include a hierarchy of page tables that provides mappings 214 implemented using PTEs 215. In this embodiment, mappings 214 would map VPNs to MPNs. Paging subsystem 130 exposes page tables 212 to MMU 118. In turn, MMU 118 cooperates with paging subsystem 130 using page tables 212 to translate VPNs to MPNs. Paging subsystem 130 intercepts page table updates performed by paging subsystem 134 in guest OS 132 in order to keep page tables 212 coherent with guest page tables 204. Software virtualization of MMU 118 is transparent to guest OS 132.

In another embodiment, CPU 108 can include hardware-assisted virtualization features, such as support for hardware virtualization of MMU 118. For example, modern x86 processors from Intel Corporation include support for MMU virtualization using extended page tables (EPTs), and modern x86 processors from Advanced Micro Devices, Inc. include support for MMU virtualization using Rapid Virtualization Indexing (RVI). Other processor platforms may support similar MMU virtualization. In general, CPU 108 can implement hardware MMU virtualization using nested page tables (NPTs). In an NPT scheme, guest OS 132 maintains VPN-to-PPN mappings 206 in guest page tables 204. Hypervisor 116 maintains mappings 214 of PPNs to MPNs in page tables 212. Both guest page tables 204 and page tables 212 are exposed to MMU 118. MMU 118 then performs a composite translation of a VPN to an MPN using both guest page tables 204 and page tables 212. This eliminates both the need for maintaining coherent shadow page tables and the overhead associated therewith. The page sharing techniques described herein can be used with both software MMU virtualization and hardware MMU virtualization schemes.

In the embodiment shown, system memory 110 is organized into pages 122 for use by VMs 120. System memory 110 include other pages for internal use by hypervisor 116 (not shown). Pages 122 are identified by MPNs in host physical memory 218. Pages in guest physical memory 210 related to pages 122 using PPN-to-MPN mappings. Pages in guest virtual memory 208 are related to pages 122 using VPN-to-MPN mappings. As discussed below, some of pages 122 may be shared among VMs 120 (“shared pages 123”). System memory 110 stores page table structures 124, which include guest page tables 204 and page tables 212 maintained by hypervisor 116. Some or all of page table structures 124 are exposed to MMU 118 for translating VPNs to MPNs. System memory 110 also stores other types of data structures 126 associated with pages 122, such as MPN-PPN map 216, a hash table 220 used for page sharing, copy-on-write (COW) indicators 222, copy-on-read (COR) indicators 224, read tracking table 240, and the like. Hash table 220, COW indicators 222, and COR indicators 224, and read tracking table 240 are discussed below.

Paging subsystem 130 is further configured to implement a page sharing scheme. Paging subsystem 130 can determine whether pages in system memory 110 have duplicate content and can potentially share a single page among VMs 120. Notably, when multiple VMs are executing, some of the VMs can have identical sets of memory content. This presents opportunities for sharing memory across VMs (as well as within a single VM). For example, several VMs may be running the same guest OS, have the same applications, or contain the same user data. With page sharing, hypervisor 116 can reclaim duplicate pages and maintain only unique pages in system memory 110, which are shared by multiple VMs. As a result, total memory consumption by the VMs is reduced and a higher level of memory over-commitment is possible.

In an embodiment, paging subsystem 130 periodically scans pages 122 for sharing opportunities. For each candidate page, paging subsystem 130 computes a hash value based on its content. Paging subsystem 130 then uses the hash value as a key to look-up a hash table 220, in which each entry records a hash value and the MPN of a shared page. Hash table 220 can include a hierarchy of one or more tables. If the hash value matches an existing entry, paging subsystem 130 performs a full bit-by-bit comparison of the page contents between the candidate page and the shared page to exclude a false match. After a successful content match, paging subsystem 130 changes the guest-physical to host-physical mapping (e.g., PPN-to-MPN mapping in PPN-MPN map 216) of the candidate page to the shared page and flushes any previous mappings from TLB 120 and page tables 212. Hypervisor 116 can then reclaim the redundant page. The remapping of PPNs to MPNs to implement page sharing is invisible to guest OS 132 executing within VM 120. Accordingly, page sharing performed by paging subsystem 130 is also referred to as “transparent page sharing.” While an example process for transparent page sharing is described above, it is to be understood that the process of enhancing the security of transparent page sharing described below is not limited to any particular implementation of the transparent page sharing process itself.

A copy-on-write (COW) technique is used to handle writes to shared pages 123. When sharing a page, paging subsystem 130 marks the shared page as COW. In an embodiment, paging subsystem 130 can maintain COW indicators 222 associated with pages 122. Paging subsystem sets COW indicators 222 associated with shared pages 123. Paging subsystem 130 also installs a write trace for each shared page 123 (also referred to as a “write-before” trace). For example, paging subsystem 130 can include a trace installer 227 configured to install write traces. A write trace is configured to cause a minor page fault when a write operation targets the traced page. In an embodiment, a write trace is implemented by manipulating protection field(s) in PTE(s), such as setting a write-protection field 228 in each PTE 215 referencing the traced page. MMU 118 will trigger a page fault during address translation when reaching a PTE that is marked read-only (write protected). Paging subsystem 130 includes a page fault handler 226 that CPU 108 invokes when the write trace is triggered. For a given page fault, page fault handler 226 can identify the VPN and/or PPN whose translation caused the fault, as well as the reason for the fault. In response to a triggered write trace by a context, page fault handler 226 creates a private copy of the shared page for use by the writing VM. For example, page fault handler 226 can obtain the PPN mapped to the VPN that triggered the write trace (e.g., by walking guest page tables 204 in case of software MMU with shadow page tables), remap the PPN to the MPN of the private page copy, flush any previous mappings from TLB 120/page tables 212, and create a new PTE in page tables 212 that maps the VPN to the MPN of the private page copy. The shared page can continue to be shared among other VM(s) that are not writing to the shared page. When using hardware MMU virtualization, paging subsystem 130 can directly obtain the PPN where the page fault occurred, obviating the need for a guest page walk.

In a laboratory setting, it has been shown that transparent page sharing as described above on a particularly configured host can be vulnerable to cache-based side-channel attacks between contexts, such as between VMs. In response, some system administrators have elected to disable transparent page sharing out of an abundance of caution. However, by disabling transparent page sharing, total memory consumption by the contexts is increased and the potential for memory over-commitment is reduced. Accordingly, in one or more embodiments described herein, paging subsystem 130 employs transparent page sharing in a manner that prevents cached-based side-channel attacks, enhancing the security of transparent page sharing. Before describing the inventive techniques used to enhance security of transparent page sharing, an example of a cache-based side-channel attack is briefly described.

As is known, CPU 108 can include a data cache 121 to reduce average access time to data stored in system memory 110. Data cache 121 can be organized into multiple levels (e.g., L1, L2, L3, etc.). Each level of data cache 121 is organized into fixed-sized cache lines. When a process accesses data in memory for the first time, the CPU loads a block of memory (“memory line”) including the data into a cache line. When a process tries to access the same data again, the access time will be significantly lower that the first access (e.g., a cache hit occurs). Assume the guest OS in one VM is executing a process (the “target process”) that includes some secret state, such as a process performing encryption using the Advanced Encryption Standard (AES) (e.g., openssl). Such a target process can utilize a data table stored in memory during operation. Assume the guest OS in another VM is executing an instance of the target process (dummy process) along with a spy process. Assuming the same version/configuration of the target and dummy processes, two copies of the same data table will be stored in memory. After some time, the spy process assumes that the underlying memory page(s) that store the copies of the data table have been shared using transparent page sharing. The spy process flushes the desired cache lines in the CPU data cache. The spy process then waits until the target process runs a fragment of code that might use the memory lines that have been flushed from the cache in the first stage. Thereafter, the spy process reads the memory lines storing the data table and measures the time it takes to retrieve the data. Depending on the timing, the spy process decides whether the target process accessed a particular memory line, in which case the memory line would be present in the cache, or if the target process did not access a particular memory line, in which case the memory line would not be present in the cache. The spy process can exploit the timing difference between a cache hit and cache miss to determine which portions of the data table the target process accessed. If the data table access pattern is related to the secret state, then the spy process can potentially determine all or a portion of the secret state.

The above-described attack cannot succeed if the spy process and the target process do not share memory pages. Thus, the attack can be prevented by disabling transparent page sharing. However, as discussed above, disabling transparent memory sharing increases memory consumption and reduces the potential for memory over-commitment. Accordingly, in embodiments, paging subsystem 130 prevents the above-described type of attack by monitoring read operations (“reads”) targeting shared memory pages 123 and creating private copies of shared memory pages 123 if the reads satisfy a threshold read pattern. Such a security enhancement can be implemented by marking each shared memory page 123 as copy-on-read (COR), as described further below.

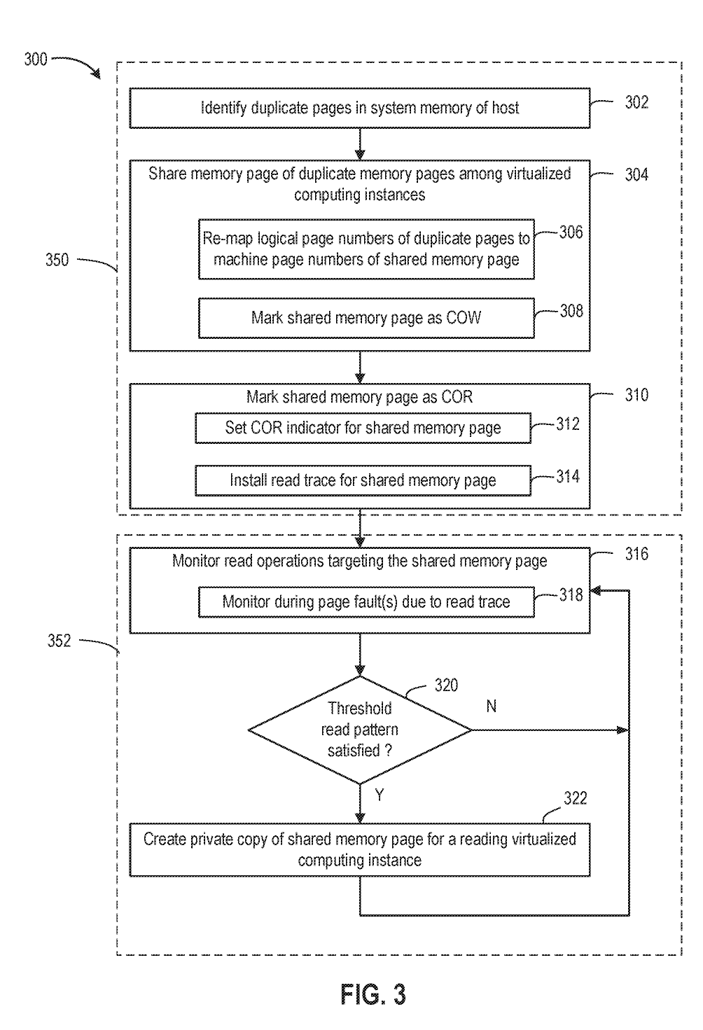

FIG. 3 is a flow diagram depicting a method 300 of enhanced-security page sharing in a virtualized computer system according to embodiments. A virtualized computer system includes a host computer having virtualization software that supports execution of a plurality of virtualized computing instances. Host 102 having hypervisor 116 is one example of a virtualized computer system in which method 300 can be performed. Accordingly, an embodiment of method 300 is described with simultaneous reference to FIGS. 1-3. Furthermore, method 300 is described in the context of de-duplicating a plurality of memory pages into a single shared page. Method 300 can be repeatedly performed to create a plurality of shared pages.

Method 300 begins at step 302, where hypervisor 116 identifies duplicate pages in system memory 110 of host 102. In an embodiment, paging subsystem module 130 scans pages 122 for sharing opportunities. Paging module 130 identifies which ones of pages 122 can be de-duplicated into a shared page 123. In an embodiment, paging module 130 implements a hashing process to identify candidate pages and a content comparison process to compare the content of the candidate pages with the content of a shared page.

At step 304, hypervisor 116 shares a memory page of the duplicate memory pages among VMs 120. In an embodiment, at step 306, paging subsystem 130 shares a memory page by re-mapping PPNs of the duplicate pages to the MPN of the shared memory page. At step 308, paging subsystem 130 also marks the shared memory page as COW. As a result, VPNs used by processes executing within VMs 120 that previously translated to multiple different MPNs of the duplicate memory pages now translate to the MPN of the shared memory page. Also, if any process within a VM 120 attempts to write to the shared memory page, paging subsystem 130 creates a private copy of the shared memory page for use by the writing process.

At step 310, hypervisor 116 marks the shared page as COR. In an embodiment, paging subsystem 130 can maintain COR indicators 224 associated with pages 122. At step 312, paging subsystem 130 sets a COR indicator 224 associated with the shared page. At step 314, paging subsystem 130 installs a read trace for the shared page (also referred to as a “read-before” trace). In an embodiment, trace installer 227 is configured to install read traces. A read trace is configured to cause a minor page fault when a read operation targets the traced page.

In an embodiment, a read trace is implemented by manipulating protection field(s) in PTE(s), such as setting field(s) 230 in each PTE 215 referencing the traced page. MMU 118 will trigger a page fault during address translation when reaching a PTE having set field(s) 230. CPU 108 invokes page fault handler 226 when a read trace is triggered. For a given page fault, page fault handler 226 can identify the VPN whose translation caused the fault, as well as the reason for the fault. A read trace can be implemented using different techniques depending on the architecture of CPU 108. For example, rather than individually installing a read trace on each page, a CPU might support a marked region in system memory 110, into which shared pages can be copied, which allow reads to pages in the marked region to be detectable. The enhanced-security page sharing techniques described herein do not presuppose any particular scheme for implementing read traces for the shared pages. All that is required is for there to be some mechanism for detecting reads to the shared pages.

At step 316, hypervisor 116 monitors read operations targeting the shared memory page. For example, a process in a VM 120 (the reading VM) can issue one or more reads to a VPN mapped to the shared page. In an embodiment, the read(s) to the VPN will trigger the read trace installed for the shared page, which causes page fault(s) that invoke page fault handler 226. As such, at step 318, hypervisor 116 can monitor read operations targeting the shared memory page during one or more page faults using page fault handler 226. Hypervisor 116 can use techniques other than read traces for monitoring read operations targeting the shared memory page. In general, page fault handler 226 detects whether the read(s) to the shared page satisfy a threshold read pattern. If the read(s) satisfy the threshold read pattern, page fault handler 226 creates a private copy of the shared page for use by the reading VM. Otherwise, page fault hander 226 continues to monitor the reads.

In an embodiment, the threshold read pattern is a single read. That is, page sharing module 130 marks the shared memory page as COR and creates a private copy of the shared memory page for any reading VM upon its first read targeting the shared memory page. Such a scheme provides the highest level of security, since one read to the shared memory page by a VM will un-share the page for that VM.

In another embodiment, the threshold read pattern is a plurality of reads. That is, page sharing module 130 marks the shared memory page as COR and creates a private copy of the shared memory page for any reading VM that issues some pattern of reads targeting the shared memory page. Such a scheme provides increased performance, since memory pages can remain shared after occasional reads. For example, the threshold pattern of reads can be any number of reads (e.g., 20 reads). In another embodiment, the threshold read pattern is a plurality of reads over a time period (e.g., 20 reads within 1 second). Page fault handler 226 can maintain a read tracking table 240. Read tracking table 240 can include entries that relate logical page number(s) (e.g., VPNs and/or PPNs) with a current read pattern (e.g., a current number of reads or a current number of reads within some time period). A read pattern to a particular logical page number mapped to the shared page that satisfies the threshold read pattern triggers creation of a private copy of the shared memory page. Note that in the embodiment where the read pattern is a single read, read tracking table 240 can be omitted. In an embodiment, hypervisor 116 can expose the threshold read pattern as a configurable parameter that can be adjusted by an administrator.

At step 320, hypervisor 116 determines whether a read pattern satisfies the threshold read pattern. If so, method 300 proceeds to step 322. Otherwise, method 300 returns to step 316. Step 320 can be implemented in page fault handler 226 as described above.

At step 322, hypervisor 116 creates a private copy of the shared memory page for a reading VM that issued reads satisfying the threshold read pattern. For example, a process in a VM 120 may have read from the shared page in a manner that satisfied the threshold read pattern. Page fault handler 226 then creates a private copy of the shared page for use by the writing VM. For example, page fault handler 226 can obtain the PPN mapped to the VPN that triggered the read trace (e.g., by walking guest page tables 204), remap the PPN to the MPN of the private page copy, flush any previous mappings from TLB 120/page tables 212, and create a new PTE in page tables 212 that maps the VPN to the MPN of the private page copy. The shared page can continue to be shared among other VM(s) that issue no reads or only occasional reads targeting the shared memory page.

Method 300 is described above with respect to the steps performed when one shared memory page is created, marked as COR, and then read by VMs 120. However, it is to be understood that the process of sharing memory pages and marking them COR is independently performed with respect to the process of monitoring reads by VMs 120. Thus, method 300 can include a method 350 for page sharing and marking shared pages as COR, and method 352 for monitoring reads among VMs 120. Hypervisor 116 can perform method 350 as one or more pages 122 are shared. Concurrently with method 350, hypervisor 116 can perform method 352 as VMs 120 read from shared pages 123.

Techniques for enhanced-security page sharing have been described above with respect to host 102 having hypervisor 116 supporting execution of VMs 120. It is to be understood that the techniques for enhanced-security page sharing described herein can be applied to other types of virtualized computing systems comprising a host computer having virtualization software. In embodiments described above, the virtualization software comprises a hypervisor that implements platform virtualization. Thus, the contexts are VMs executing guest operating systems and system memory 110 is virtualized in terms of host physical memory, guest physical memory, and guest virtual memory. Page sharing is performed at the hypervisor-level by manipulating mappings between PPNs and MPNs. In other embodiments, contexts can be other types of virtualized computing instances (an example of which is described below) executing on a hypervisor or another type of operating system. In such embodiments, the virtualized computing instances may support execution of processes without a guest operating system and system memory 110 can be virtualized in terms of machine (physical) memory and logical (virtual) memory. Page sharing is performed at the OS-level by manipulating mappings between virtual page numbers and machine page numbers. Thus, in general, page sharing can be performed by manipulating mappings between logical page numbers of a logical memory and machine page numbers of a machine memory. The enhanced-security techniques described herein can be applied to any such page sharing process.

Certain embodiments as described above involve a hardware abstraction layer implemented by virtualization software running on a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example of virtualization software providing the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user-space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers. The term “virtualization software” as used herein in meant to encompass both a hypervisor and an OS kernel that supports OS-less containers.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of page sharing in a host computer having virtualization software that supports execution of a plurality of virtualized computing instances, the method comprising:
identifying, by the virtualization software, duplicate memory pages in system memory of the host computer;
sharing a memory page of the duplicate memory pages among the plurality of virtualized computing instances;
monitoring reads by a first virtualized computing instance targeting the shared memory page; and
creating a private copy of the shared memory page for the first virtualized computing instance in response to the reads satisfying a threshold read pattern.

2. The method of claim 1, wherein the threshold read pattern comprises a single read.

3. The method of claim 1, wherein the threshold read pattern comprises a plurality of reads.

4. The method of claim 1, wherein the threshold read pattern comprises a plurality of reads within a time period.

5. The method of claim 1, further comprising:
installing a read trace for the shared memory page.

6. The method of claim 5, wherein the step of monitoring is performed in response to one or more page faults triggered by the read trace.

7. The method of claim 5, wherein the step of installing the read trace comprises setting one or more fields of a page table entry referencing the shared memory page that will cause a page fault in response to a read targeting the shared memory page.

8. The method of claim 1, wherein the virtualization software comprises a hypervisor and the plurality of virtualized computing instances is a plurality of virtual machines.

9. The method of claim 1, wherein the virtualization software comprises an operating system and the plurality of virtualized computing instances is a plurality of containers.

10. The method of claim 1, wherein the step of sharing the memory page comprises re-mapping a logical page number associated with the memory page to a machine page number associated with the memory page.

11. A computer system, comprising:
a hardware platform having a central processing unit (CPU) and a system memory; and
virtualization software executing on the hardware platform, the virtualization software supporting execution of a plurality of virtualized computing instances, the virtualization software configured to:
identify duplicate memory pages in the system memory;
share a memory page of the duplicate memory pages among the plurality of virtualized computing instances;
monitor reads by a first virtualized computing instance targeting the shared memory page; and
create a private copy of the shared memory page for the first virtualized computing instance in response to the reads satisfying a threshold read pattern.

12. The computer system of claim 11, wherein the threshold read pattern comprises a single read, a plurality of reads, or a plurality of reads within a time period.

13. The computer system of claim 11, wherein the virtualization software is further configured to install a read trace for the shared memory page, and wherein virtualization software monitors the reads in response to one or more page faults triggered by the read trace.

14. The computer system of claim 11, wherein the virtualization software comprises a hypervisor and the plurality of virtualized computing instances is a plurality of virtual machines.

15. The computer system of claim 11, wherein the virtualization software comprises an operating system and the plurality of virtualized computing instances is a plurality of containers.

16. A non-transitory computer readable medium having instructions stored thereon that when executed by a processor cause the processor to perform a method of page sharing in a host computer having virtualization software that supports execution of a plurality of virtualized computing instances, the method comprising:
identifying, by the virtualization software, duplicate memory pages in system memory of the host computer;
sharing a memory page of the duplicate memory pages among the plurality of virtualized computing instances;
monitoring reads by a first virtualized computing instance targeting the shared memory page; and
creating a private copy of the shared memory page for the first virtualized computing instance in response to the reads satisfying a threshold read pattern.

17. The non-transitory computer readable medium of claim 16, wherein the threshold read pattern comprises a single read, a plurality of reads, or a plurality of reads within a time period.

18. The non-transitory computer readable medium of claim 16, further comprising:
installing a read trace for the shared memory page;
wherein the step of monitoring is performed in response to one or more page faults triggered by the read trace.

19. The non-transitory computer readable medium of claim 16, wherein the virtualization software comprises a hypervisor and the plurality of virtualized computing instances is a plurality of virtual machines.

20. The non-transitory computer readable medium of claim 16, wherein the virtualization software comprises an operating system and the plurality of virtualized computing instances is a plurality of containers.
